(19) United States
(12) Patent Application Publication
(10) Pub. No.: US 2017/0046641 A1
(43) Pub. Date: Feb. 16, 2017

(54) BUSINESS RECOMMENDATIONS BASED ON STATE MACHINE INFERENCE

(71) Applicant: GOOGLE INC., MOUNTAIN VIEW, CA (US)

(72) Inventor: Jennifer Anne LEES, San Jose, CA (US)

(73) Assignee: GOOGLE INC., Mountain View, CA (US)

(21) Appl. No.: 14/145,558

(22) Filed: Dec. 31, 2013

Related U.S. Application Data
(60) Provisional application No. 61/785,892, filed on Mar. 14, 2013.

(51) Int. Cl. G06Q 10/06

(52) U.S. Cl. CPC G06Q 10/0637

(57) ABSTRACT

A system and computer-implemented method is provided for providing a business with smart recommendations, the method including receiving information regarding a business, determining a state of a plurality of states of a finite state machine based on the information regarding the business, the plurality of states referring to different stages of the business process in achieving a goal associated with the business, assigning the business to the determined state, determining one or more actions associated with the determined state, where the one or more actions provide actions that advance the business to a different state of the plurality of states that provide one or more paths of progress until the business has stabilized at a stable state indicating that the business has achieved the goal and providing the one or more actions as recommendations for display to the business at a client device associated with the business.

### CROSS-REFERENCE TO RELATED APPLICATIONS

The present application claims the benefit of priority under 35 U.S.C. §119 from U.S. Provisional Patent Application No. 61/785,892 entitled “BUSINESS RECOMMENDATIONS BASED ON STATE MACHINE INFERENCE”, filed on Mar. 14, 2013, the disclosure of which is hereby incorporated by reference in its entirety for all purposes.

### BACKGROUND

Business owners subscribe to multiple services, both online and offline, to help manage their business. Increasingly, business success is becoming dependent on effective use of these services, from marketing to discoverability to customer engagement tools. However, often, the average business owner is not technically savvy and may not be aware of or become overwhelmed by the wide range of services available for a business to grow and maintain business success and development. In addition, small business owners are likely to operate independent from any knowledge of the overall market and thus are unable to take advantage of the wealth of learning and behavior from similar businesses in the market. It would be beneficial to provide businesses with recommendations for taking actions to improve their businesses based on market information and the different resources and tools available to these businesses.

### SUMMARY

The disclosed subject matter relates to a computer-implemented method for providing a business with smart recommendations, the method comprising receiving, using one or more computing devices, information regarding a business. The method may further comprise determining, using the one or more computing devices, a state of a plurality of states of a finite state machine based on the information regarding the business, the plurality of states referring to different stages of the business process in achieving a goal associated with the business. The method may further comprise assigning, using the one or more computing devices, the business to the determined state. The method may further comprise determining, using the one or more computing devices, one or more actions associated with the determined state, wherein the one or more actions provide actions that advance the business to a different state of the plurality of states, wherein the plurality of states provide one or more paths of progress until the business has stabilized at a stable state indicating that the business has achieved the goal and providing, using the one or more computing devices, the one or more actions as recommendations for display to the business at a client device associated with the business.

The disclosed subject matter also relates to a system for providing a business with smart recommendations, the system comprising one or more processors and a machine-readable medium comprising instructions stored therein, which when executed by the processors, cause the processors to perform operations comprising receiving an indication of a request to provide a business with one or more recommended actions for achieving a goal. The operations may further comprise receiving information regarding the business, the information comprising one or more of one or more actions taken by the business or one or more actions taken by one or more users towards the business or one or more business characteristics. The operations may further comprise determining a plurality of states of a finite state machine associated with the goal, the plurality of states referring to different stages of the business process in achieving the goal. The operations may further comprise identifying a state of the plurality of states based on the information regarding the business. The operations may further comprise assigning the business to the determined state. The operations may further comprise determining one or more actions associated with the determined state, wherein the one or more actions provide actions that advance the business to a different state of the plurality of states, wherein the plurality of states provide one or more paths of progress until the business has stabilized at a stable state indicating that the business has achieved the goal and providing the one or more actions for display to the business in response to the request.

The disclosed subject matter also relates to a machine-readable medium comprising instructions stored therein, which when executed by a machine, cause the machine to perform operations comprising receiving an indication of a request to provide a business with one or more recommended actions for achieving a goal. The operations may further comprise receiving information regarding the business. The operations may further comprise determining a plurality of states of a finite state machine associated with the goal, the plurality of states referring to different stages of the business process in achieving the goal. The operations may further comprise identifying a state of the plurality of states based on the information regarding the business. The operations may further comprise assigning the business to the determined state. The operations may further comprise determining one or more actions associated with the determined state, wherein the one or more actions comprise actions that advance the business to a different state of the plurality of states, wherein the plurality of states provide one or more paths of progress until the business has stabilized at a stable state indicating that the business has achieved the goal. The operations may further comprise providing the one or more actions for display to the business. The operations may further comprise receiving updated information regarding the business in response to the business performing the at least one of the one or more actions and determining a second state of the plurality of states based on the updated information.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example client-server network environment which provides for a smart recommendation system for a business owner based on a holistic overview of the business.

FIG. 2 illustrates a flow diagram of an example process for providing smart recommendations to a business owner based on a holistic overview of the business.

FIG. 3 illustrates an example diagram of the states of a finite state machine for facilitating providing smart recommendations to a business owner based on a holistic overview of the business.

FIG. 4 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

I. Overview

The subject disclosure provides a smart recommendation system for providing recommendations of actions to a business owner based on a holistic overview of the business. The recommendation system may be applied to a narrower data source, while the quality of recommendations improves when coupled with a wide range of data about the business and/or other similar businesses.

The smart recommendation system provides a recommendation engine that combines existing knowledge regarding a business with machine learning to provide recommendations to a business to help the business develop and grow. Given data input about the business, the business is mapped to a specific state in a finite state machine. The input data regarding a business may include both data provided by the business as well as information based on the past activity of the business. Such information may include business type, business goals, business market, products and services. Additionally, information regarding customers of the business such as number of users who looked up the business, got directions to the business, number of customer reviews, content of the reviews, as well as social activity information regarding the business may be used to determine the state that the business is currently in.

Each state in the state machine is defined based on various business characteristics, actions and/or milestones. For example, four different business states may be defined. “Low Customer Acquisition”, which recommends acquisition actions; “Low Customer Engagement”, which recommends engagement actions; “Low Discoverability”, which recommends discoverability actions, and “Good Performance”, which recommends maintenance actions (e.g. if the user has a social networking page, a default low priority and/or maintenance action is “Post to Social Networking Page”, only shown when no higher priority social networking related actions are relevant).

Each state may define a specific stage within a life cycle of one or more goals that the business wishes to achieve. In one example, the system may treat each business goal separately or may group one or more goals, when defining states and/or providing recommendations for the business. In one example, the mapping of actions to different states is performed based on holistic information available regarding the business, similar businesses, the overall market or other information that is relative to defining actions that are likely to advance a business through a state. In one example, actions are then selected based on current information regarding the business and/or market, the resources available to the business and/or preferences of the business.

The state definitions are dynamically updated using machine learning and may be defined based on a combination of explicit input from one or more users (e.g., experts) and/or data regarding one or more other businesses (e.g., businesses with similarities including market share, target market, offered services and products, geographic location, etc.). Each state further contains recommendations to move to future states, based on the data available about the business and/or other similar businesses.

Once a business is mapped to a specific state, recommendations are provided to the user (e.g., business owner/operator/agent). The selection of recommendations may be based on information regarding the business including previously completed actions, resources, preferences, and/or similar information regarding other businesses.

Once the user receives the recommendations and takes one or more recommended actions, the system receives indication of such actions and reevaluates the state of the business and provides additional recommendations to advance the business through various states until ultimately the business stabilizes on a final state indicating that the business has achieved the one or more goals associated with the recommendations and state definitions.

II. Example Client-Server Network Environments for Facilitating a Smart Recommendation System

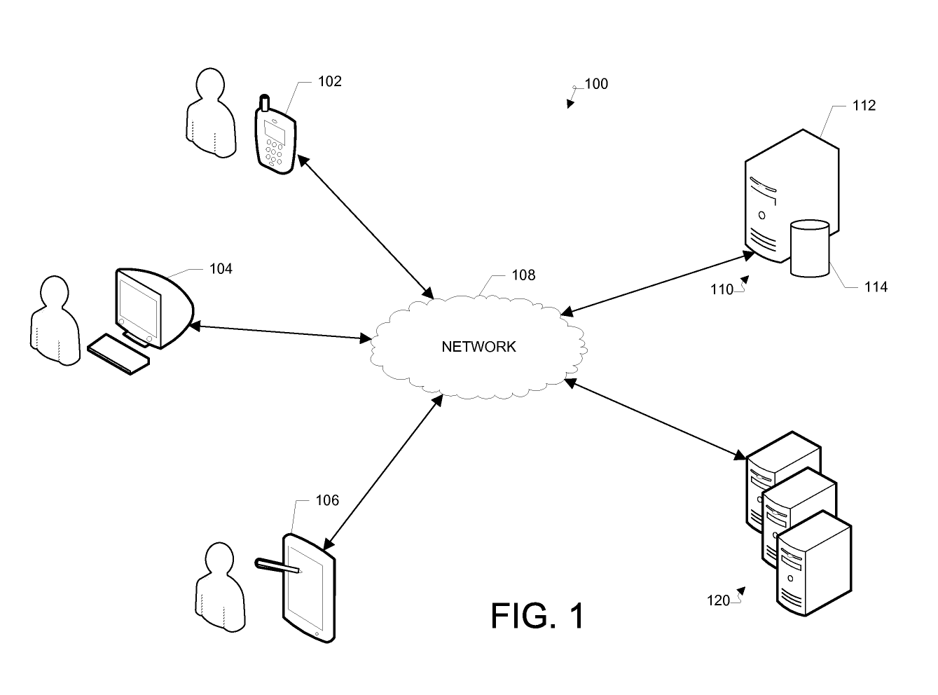

FIG. 1 illustrates an example client-server network environment which provides for a smart recommendation system for a business owner based on a holistic overview of the business. A network environment 100 includes a number of electronic devices 102, 104 and 106 communicably connected to a server 110 by a network 108. One or more remote servers 120 are further coupled to the server 110 and/or the one or more electronic devices 102, 104 and 106.

In some example embodiments, electronic devices 102, 104 and 106 can be computing devices such as laptop or desktop computers, smartphones, PDAs, portable media players, tablet computers, televisions or other displays with one or more processors coupled thereto or embedded therein, or other appropriate computing devices that can be used to for displaying a web page or web application. In one example, the electronic devices 102, 104 and 106 store a user agent such as a browser or application. In the example of FIG. 1, electronic device 102 is depicted as a smartphone, electronic device 104 is depicted as a desktop computer, and electronic device 106 is depicted as a PDA.

Server 110 includes a processing device 112 and a data store 114. Processing device 112 executes computer instructions stored in data store 114, for example, to assist in providing smart recommendations for a business owner interacting with electronic devices 102, 104 and 106 based on a holistic overview of the business.

In some example aspects, server 110 can be a single computing device such as a computer server. In other embodiments, server 110 can represent more than one computing device working together to perform the actions of a server computer (e.g., cloud computing). The server 110 may host the web server communicationally coupled to the browser at the client device (e.g., electronic devices 102, 104 or 106) via network 108. In one example, the server 110 may host a smart recommendation system for a business owner based on a holistic overview of the business. Server 110 may further be in communication with remote servers 120 either through the network 108 or through another network or communication means.

Each of the one or more remote servers 120 can be a single computing device such as a computer server or can represent more than one computing device working together to perform the actions of a server computer (e.g., cloud computing). In one example, the one or more other remote servers 120 may host services and applications providing various functionalities and/or storage capabilities to assist with the techniques described herein with regard to the system hosted the server 110 either alone or in combination with server 110. Server 110 may further maintain or be in communication with social networking services hosted on one or more remote server 120.

Communications between the client devices 102, 104, 106, server 110 and/or one or more remote servers 120 may be facilitated through the HTTP communication protocol. Other communication protocols may also be facilitated including for example, XMPP communication, for some or all communications between the client devices 102, 104, 106, server 110 and one or more remote servers 120 (e.g., through network 108).

Users may interact with the system hosted by server 110, and/or one or more social networking services hosted by remote servers 120, through a client application installed at the electronic devices 102, 104, 106. Alternatively, the user may interact with the system and the one or more social networking services through a web based browser application at the electronic devices 102, 104, 106. Communication between client devices 102, 104, 106 and the system, and/or one or more social networking services, may be facilitated through a network (e.g., network 108).

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

III. Example Processes for Facilitating a Smart Recommendation System

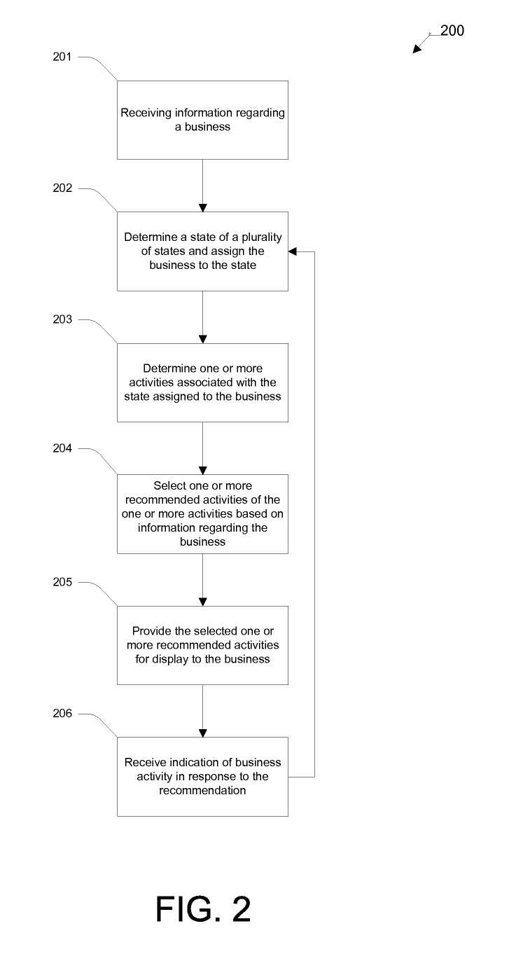

FIG. 2 illustrates a flow diagram of an example process 200 for providing smart recommendations to a business owner based on a holistic overview of the business.

In block 201, the system receives information regarding the business. The business may include any entity or individual having an interest in promoting, marketing or offering for consumption and/or sale one or more products, services and/or information. The business information may include both information provided by the business as well as information determined based on past activity of the business, one or more customers and/or or one or more other businesses.

The information regarding the business may include one or more business characteristics such as business type, business category, business geographic location, or types of products and services offered by the business, actions taken by the business including creating a social networking page, creating a web page, creating one or more business listings, creating an advertisement campaign, creating one or more offers, or creating loyalty programs and/or actions taken by one or more other users towards the business including number of searches of the business, number of mentions of the business, content of reviews regarding the business, or number of social actions taken with respect to the business.

In block 202, the system determines a state of a plurality of states of a finite state machine and assigns the business to the state. Each state may define a specific stage within a life cycle of one or more goals that the business wishes to achieve. In one example, the system may treat each business goal separately or may group one or more goals, when defining states within the finite state machine. In one example, for each specific set of one or more goals of a business, a different set of states may be defined, and the business may be assigned to a state of a set of states relating to goals that the business needs to achieve. In one example, goals of the business may be determined based on various business information and/or activity, and/or may be explicitly provided by the business.

Each state in the state machine is defined based on various business characteristics, actions and/or milestones. That is, the states are each defined based on the characteristics of businesses that would fall within that state, as defined by business information, characteristics, activity and status with respect to one or more goals associated with the plurality of states.

The state definitions are dynamically updated using machine learning and may be defined based on a combination of explicit input from one or more users (e.g., experts) and/or data regarding one or more businesses (e.g., businesses with similarities including market share, target market, offered services and products, geographic location, etc.). Based on the information of the business, and the definition of the plurality of states, the business is mapped to a specific state in a finite state machine.

In block 203, the system determines one or more activities associated with the state assigned to the business. Each state is associated with recommended actions that may be taken by a business to advance to other states and eventually achieve the one or more goals relating to the plurality of states. In one example, actions for each state are defined based on holistic information available regarding the business, similar businesses, the overall market or other information that is relative to defining actions that are likely to advance a business through a state (e.g., by determining that the business has met the objectives of the specific state). In one example, actions may be mapped to a state based on historical information indicating that a certain action is likely to lead to a specific result. In one example, one or more actions may be manually linked to each of the plurality of states. In one example, various applications may provide certain functionalities that may be helpful for achieving a certain goal or advancing from one state to another state. These functionalities may be used to define actions for the plurality of states.

In block 204, one or more of the determined activities are selected as recommended actions based on one or more criteria. In one example, actions may be selected based on current information regarding the business and/or market as well as the resources available to the business (e.g., the different tools and/or applications) and/or preferences of the business. In one example, criteria for selecting an action may include actions previously taken by the business, actions previously taken by one or more other businesses that are determined to be similar or related to the business, resources available to the business and/or listing of resources (e.g., tools and applications, information, venues, forums, etc.) available to the business.

In one example, the actions by the business may include one or more actions already performed by the business. In one example, actions by the business may be considered such that the recommended actions support the actions already performed by the business. In another example, recommended actions may be selected such that they are not duplicative or contrary to actions already performed by the business. Prior actions by other businesses may also be considered, for example to identify which actions are most likely to lead to results based on the characteristics and actions of the business. In one example, for each action there is a priority or effectiveness score, such that actions with highest priority and/or effectiveness score are selected. Priority of an action may be based on business or system preferences, manual priorities assigned to an action, or the action being a prerequisite to one or more other actions. In one example, an effectiveness score indicates the likelihood that an action leads to a desired result. The effectiveness score may be determined based on the historical results with respect to the action with respect to one or more businesses (e.g., businesses similar to the business or the overall market).

In block 205, the one or more recommended actions are provided for display to the business. The actions provided to the user may be recommended because they relate to tools and applications (resources) available to the business. In one example, a desired action is provided with an identifier of the specific tool or application that can be used to perform the action. The user may then view the recommended actions and may perform one or more of recommended actions. The one or more recommended actions may include one or more of creating a social networking page, creating a web page, creating one or more business listings, creating an advertisement campaign, creating one or more offers, creating loyalty programs, providing customer comment mechanisms, performing reputation management, examining competitors, or investigating new products.

In block 206, the system receives an indication of business activity. The business activity may for example include the business performing one or more of the recommended actions and/or one or more other actions. In one example, the business activity may also include one or more changes to business preferences. In response to receiving indications of business activity, the process may return to block 202 and the system may reevaluate the state of the business and provides additional recommendations until ultimately the business stabilizes on a final state.

A state of a finite state machine can transition to one or more other states. In one example, transition may be defined based on whether the business activity and information of the business places the business within one of the states to which the business can transition to from the current state. In some implementations, transitions may occur when a threshold requirement for the current state is met (e.g., a threshold level of discoverability, customer acquisition or customer engagement). In one example, once it is determined that the business can move to another state, the valid available states that the business can transition to from its current state are evaluated according to the business information and activity as well as the definitions/transition criteria for the one or more states to determine a state for the business.

In one implementation, in addition to business activity, the state of the business may also be reevaluated based on other events including, for example, events that lead to updating the definition of a state. In one example, the recommended actions provided to the user may be updated with recommended actions, when new actions are mapped to a state the user is in, on a periodic basis and/or in response to an explicit request. In one example, if it is determined that the user has reached a final state, the user may be provided with actions to help maintain the state of the user, for example, until the user does not wish to receive further recommendations, the state of the user changes, or the process otherwise terminates.

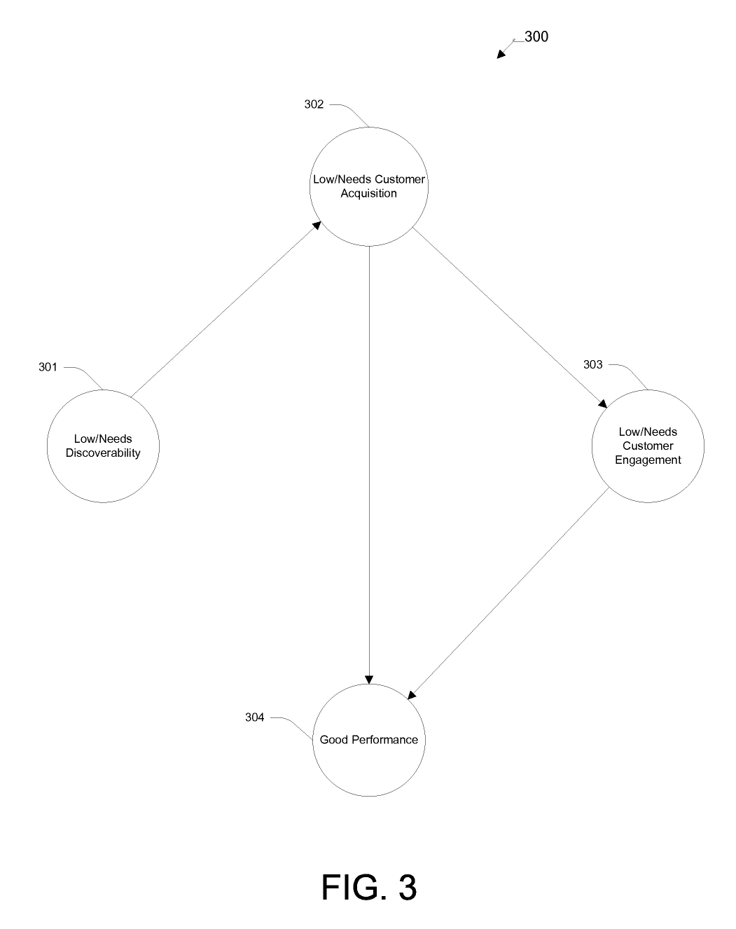

FIG. 3 illustrates an example diagram 300 of the states of a finite state machine for facilitating providing smart recommendations to a business owner based on a holistic overview of the business. The goal associated with the finite state machine may for example include acquiring and maintaining customers.

As illustrated four different business states may be identified in the life cycle of achieving the goal of acquiring and maintaining customers. A “Low/Needs Discoverability” state 301 may indicate that based on business information the business has low discoverability (e.g., the business has not yet been discovered by a threshold number of customers). While a business is assigned to state 301, the system may recommend discoverability actions that may help improve the discoverability of the business. Such actions may include creating a social networking page, creating a web page and/or creating one or more business listings.

In one example, once a business has gained enough discoverability the business may move to a second “Low/Needs Customer Acquisition” state 302, indicating that the business has low customer acquisition (e.g., the business has not acquired a threshold number of customers or market share). When the system determines that a business is in state 302, the system recommends acquisition actions such as creating an advertisement campaign, creating one or more offers to provide customer acquisition opportunities for the business.

From state 302, the business may advance to a third “Low/Need Customer Engagement” state 303 indicating that the customer engagement with the business needs improvement (the business has not engaged a threshold number of customers and/or loyal customer). When in this state, the business receives engagement actions that may be taken by the business to improve customer engagement with the business. Engagement actions may include, creating loyalty programs, providing customer comment mechanisms and/or performing reputation management. From either state 302 or state 303 the business may also move to a “Good Performance” state 304. At this stage the system may recommend maintenance actions.

IV. Example System for Facilitating a Smart Recommendation System

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

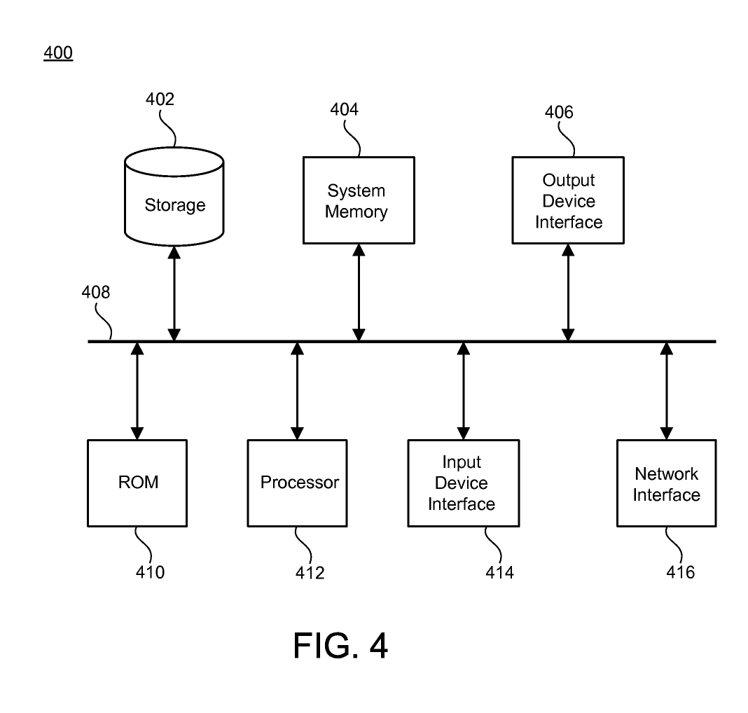

FIG. 4 conceptually illustrates an electronic system with which some implementations of the subject technology are implemented. Electronic system 400 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 400 includes a bus 408, processing unit(s) 412, a system memory 404, a read-only memory (ROM) 410, a permanent storage device 402, an input device interface 414, an output device interface 406, and a network interface 416.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, and/or ROM 410. For example, the various memory units include instructions for providing smart recommendations to a business owner based on a holistic overview of the business according to various embodiments. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 406 include, for example, printers and display devices, such as cathode ray tubes (CRT) or liquid crystal displays (LCD). Some implementations include devices such as a touchscreen that functions as both input and output devices.

Finally, as shown in FIG. 4, bus 408 also couples electronic system 400 to a network (not shown) through a network interface 416. In this manner, the computer can be a part of a network of computers (such as a local area network (“LAN”), a wide area network (“WAN”), or an Intranet, or a network of networks, such as the Internet. Any or all components of electronic system 400 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of blocks in the processes disclosed is an illustration of exemplary approaches. Based upon design preferences, it is understood that the specific order or hierarchy of blocks in the processes may be rearranged, or that some illustrated blocks may not be performed. Some of the blocks may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure. Features under one heading may be combined with features under one or more other heading and all features under one heading need not be use together. Features under one heading may be combined with features under one or more other heading and all features under one heading need not be use together.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method for providing a business with smart recommendations, the method comprising:
receiving, using one or more computing devices, information regarding a business, the information regarding the business comprising one or more of received information provided by the business and received information associated with past activity of the business;
determining, using the one or more computing devices, a state of a plurality of states of a finite state machine based on the information regarding the business, the plurality of states defining different stages of the business process in achieving a goal associated with the business and being defined based on one or more of user input and data associated with businesses having similarities to the business, the plurality of states being dynamically updated using machine learning;
assigning, using the one or more computing devices, the business to the determined state;
determining, using the one or more computing devices, one or more actions associated with the determined state, wherein the one or more actions are determined from a plurality of actions based at least in part on effectiveness scores associated with each action of the plurality of actions, the effectiveness scores indicating a likelihood that an action leads to a desired result, wherein the one or more actions provide actions that advance the business to a different state of the plurality of states, the business advance to a different state occurring when a threshold requirement for the determined state is met, wherein the plurality of states provide one or more paths of progress until the business has stabilized at a stable state indicating that the business has achieved the goal; and
providing, using the one or more computing devices, the one or more actions as recommendations for display to the business at a client device associated with the business.

2. The method of claim 1, further comprising:
receiving an indication of the business performing at least one of the one or more actions; and
determining a second state of the plurality of states based on the information and the indication.

3. The method of claim 1, further comprising:
receiving updated information regarding the business in response to the business performing the at least one of the one or more actions; and
determining a state of the plurality of states based on the updated information.

4. The method of claim 1, wherein the goal comprises acquiring and maintaining customers.

5. The method of claim 1, wherein the state of the plurality of states comprises discoverability state where the business has not yet been discovered by a threshold number of customers, wherein the one or more actions comprise actions that may be taken by the business to improve discoverability of the business.

6. The method of claim 1, wherein the state of the plurality of states comprises a customer acquisition stage where the business has not acquired a threshold number of customers, wherein the one or more actions comprise actions that may be taken by the business to improve customer acquisition opportunities for the business.

7. The method of claim 1, wherein the state of the plurality of states comprises a customer engagement stage wherein the business has not engaged a threshold number of customers, wherein the one or more actions comprise actions that may be taken by the business to improve customer engagement with the business.

8. The method of claim 1, wherein the state of the plurality of states comprises a good performance stage, wherein the good performance stage indicates that the business has achieved the goal, wherein the one or more actions comprise actions that may be taken by the customers to maintain the state.

9. The method of claim 1, wherein the information regarding the business comprises one or more business characteristics such as business type, business category, business geographic location, or types of products and services offered by the business.

10. The method of claim 1, wherein the information regarding the business comprises actions taken by the business including creating a social networking page, creating a web page, creating one or more business listings, creating an advertisement campaign, creating one or more offers, or creating loyalty programs.

11. The method of claim 1, wherein the information regarding the business comprises actions taken by one or more users towards the business including number of searches for the business, number of mentions of the business, content of reviews regarding the business, or number of social actions taken with respect to the business.

12. The method of claim 1, wherein the one or more actions include one or more of creating a social networking page, creating a web page, creating one or more business listings, creating an advertisement campaign, creating one or more offers, creating loyalty programs, providing customer comment mechanisms, performing reputation management, examining competitors, or investigating new products.

13. The method of claim 1, wherein the determining the one or more actions comprise:
identifying a plurality of actions associated with the state, wherein the plurality of actions represent actions that may be taken by the business to advance to one or more other states of the plurality of states until the business is at a stage of the plurality of stages indicating that the user has achieved the goal; and
selecting the one or more actions from the plurality of actions based on one or more criteria.

14. The method of claim 13, wherein the one or more criteria includes one or more of actions previously taken by the business or one or more other businesses that are determined to be similar or related to the business, preferences of the business or resources available to the business,

15. A system for providing a business with smart recommendations, the system comprising:
one or more processors; and
a machine-readable medium comprising instructions stored therein, which when executed by the processors, cause the processors to perform operations comprising:
receiving an indication of a request to provide a business with one or more recommended actions for achieving a goal;
receiving information regarding the business, the information comprising one or more of one or more actions taken by the business or one or more actions taken by one or more users towards the business or one or more business characteristics;
determining a plurality of states of a finite state machine associated with the goal,
the plurality of states defining different stages of the business process in achieving the goal and being defined based on one or more of user input and data associated with businesses having similarities to the business, the plurality of states being dynamically updated using machine learning;
identifying a state of the plurality of states based on the information regarding the business;
assigning the business to the determined state;
determining one or more actions associated with the determined state, wherein the one or more actions are determined from a plurality of actions based at least in part on effectiveness scores associated with each action of the plurality of actions, the effectiveness scores indicating a likelihood that an action leads to a desired result, wherein the one or more actions provide actions that advance the business to a different state of the plurality of states, the business advance to a different state occurring when a threshold requirement for the determined state is met, wherein the plurality of states provide one or more paths of progress until the business has stabilized at a stable state indicating that the business has achieved the goal; and
providing the one or more actions for display to the business in response to the request

16. The system of claim 15, the operations further comprising:
receiving an indication of the business performing at least one of the one or more actions; and
determining a second state of the plurality of states based on the indication.

17. The system of claim 16, the operations further comprising:
receiving updated information regarding the business in response to the business performing the at least one of the one or more actions; and
determining the second state of the plurality of states based on the updated information.

18. A non-transitory machine-readable medium comprising instructions stored therein, which when executed by a machine, cause the machine to perform operations comprising:
receiving an indication of a request to provide a business with one or more recommended actions for achieving a goal;
receiving information regarding the business, the information regarding the business comprising one or more of received information provided by the business and received information associated with past activity of the business;
determining a plurality of states of a finite state machine associated with the goal, the plurality of states defining different stages of the business process in achieving the goal and being defined based on one or more of user input and data associated with businesses having similarities to the business, the plurality of states being dynamically updated using machine learning;
identifying a state of the plurality of states based on the information regarding the business;
assigning the business to the determined state;
determining one or more actions associated with the determined state, wherein the one or more actions are determined from a plurality of actions based at least in part on effectiveness scores associated with each action of the plurality of actions, the effectiveness scores indicating a likelihood that an action leads to a desired result, wherein the one or more actions comprise actions that advance the business to a different state of the plurality of states, the business advance to a different state occurring when a threshold requirement for the determined state is met, wherein the plurality of states provide one or more paths of progress until the business has stabilized at a stable state indicating that the business has achieved the goal; and
providing the one or more actions for display to the business;
receiving updated information regarding the business in response to the business performing the at least one of the one or more actions; and
determining a second state of the plurality of states based on the updated information.

19. The machine-readable medium of claim 18, the operations further comprising:
determining one or more other actions associated with the second state, wherein the one or more actions provide actions that advance the business to a different state of the plurality of states until the business has stabilized at a state indicating that the business has achieved the goal; and
providing the one or more other actions for display to the business.

20. The machine-readable medium of claim 18, wherein the information comprises one or more of one or more actions taken by the business or one or more actions taken by one or more users towards the business or one or more business characteristics.
